(19) United States
(12) Patent Application Publication
(10) Pub. No.: US 2008/0145508 A1
(43) Pub. Date: Jun. 19, 2008

(54) Alcoholic beverage mixture

(76) Inventor: Dennis D. Banfield, Platteville, WI (US)

Correspondence Address: JAMES RAY & ASSOCIATES, 2640 PITCAIRN ROAD, MONROEVILLE, PA, 15146, US

(21) Appl. No.: 12/001,660

(22) Filed: Dec. 12, 2007

Related U.S. Application Data
(60) Provisional application No. 60/869,752, filed on Dec. 13, 2006.

(51) Int. Cl. C12G 3/04; C12G 3/06

(52) U.S. Cl. 426/592; 426/519

(57) ABSTRACT

An alcoholic beverage mixture consisting essentially of pre-selected amounts of apple cider, apple juice, a sweetening agent, cinnamon and an alcoholic agent.

### CROSS REFERENCE TO RELATED APPLICATION

This application is closely related to and claims priority from U.S. Provisional Patent Application Ser. No. 60/869,752 filed on Dec. 12, 2006.

### FIELD OF THE INVENTION

The present invention relates, in general, to alcoholic beverages and, more particularly, the invention relates to an alcoholic beverage mixture that combines the ingredients used in making a traditional apple pie or apple dumplings with alcohol.

### BACKGROUND OF THE INVENTION

Many individuals do not enjoy the harsh or bitter taste of beer or plain liquors, such as whiskey or vodka, and are constantly asking bartenders, waiters or waitresses for a sweeter alternative to these alcoholic beverages. Thus, bars and restaurants are always searching for new, unique drinks that they can offer their patrons. These drinks usually provide additional revenue for the establishment, as they are typically priced higher than other more familiar drinks. In addition, when throwing a party or hosting a gathering, people desire a new and exciting drink to offer their guests that will ensure their party is memorable.

### SUMMARY OF THE INVENTION

One aspect of the present invention provides an alcoholic beverage mixture. The alcoholic beverage mixture essentially consists of pre-selected amounts of apple cider, apple juice, sweetening agent, cinnamon in the form of at least one of sticks and powder and an alcoholic agent.

A second aspect of the present invention provides a method of preparing an alcoholic beverage mixture. The method includes the step of selecting a suitable container to combine the alcoholic beverage mixture in. This is followed by the step of pouring pre-selected amounts of apple cider and apple juice into the container. The next step is adding pre-selected amounts of a sweetening agent and cinnamon in the form of at least one of sticks and powder to the pre-selected amounts of apple cider and apple juice poured in the container. This is followed by the step of boiling the pre-selected amounts of apple cider, apple juice, sweetening agent and cinnamon mixed together in the previous steps a pre-selected amount of time. The next step is allowing the mixture boiled in the previous step to cool a pre-selected amount of time. The method includes the step of pouring a pre-selected amount of an alcoholic agent into the mixture cooled in the previous step.

### OBJECTS OF THE INVENTION

It is, therefore, one of the primary objects of the present invention to provide an alcoholic beverage mixture that combines the ingredients of a traditional apple pie or apple dumplings with alcohol.

Another object of the present invention is to provide an alcoholic beverage mixture that can be consumed as a drink or poured over other dessert items.

Still another object of the present invention is to provide an alcoholic beverage mixture that can be served and/or sold in commercial establishments, such as bars, restaurants and stores having a liquor license.

Yet another object of the present invention is to provide an alcoholic beverage mixture that is easy to prepare.

In addition to the various objects and advantages of the present invention described with some degree of specificity above it should be understood that additional objects and advantages of the present invention will become more readily apparent to those persons who are skilled in the relevant art from the following more detailed description of the invention, particularly, when such description is taken in conjunction with the appended claims.

### DETAILED DESCRIPTION OF A PRESENTLY PREFERRED AND VARIOUS ALTERNATIVE EMBODIMENTS OF THE INVENTION

The present invention combines ingredients used in making apple pie or apple dumplings with alcohol. An alcoholic beverage mixture consisting essentially of pre-selected amounts of apple cider, apple juice, a sweetening agent, cinnamon in the form of at least one of sticks and powder and an alcoholic agent.

A method of preparing the alcoholic beverage mixture includes selecting a suitable container to combine the alcoholic beverage mixture in. Next, the pre-selected amounts of apple cider and apple juice are poured into the container. Then, the pre-selected amounts of sweetening agent and cinnamon are added to the pre-selected amounts of apple cider and apple juice in the container. Next, the pre-selected amounts of apple cider, apple juice, sweetening agent and cinnamon previously mixed together are boiled a pre-selected amount of time, preferably for about seven minutes. Then, the mixture is allowed to cool a pre-selected amount of time, preferably for about one hour. Finally, a pre-selected amount of an alcoholic agent is poured into the cooled mixture.

To yield about seven liters of the alcoholic beverage mixture, the pre-selected amounts of the above mentioned ingredients include about one gallon of apple cider, about ½ gallon of apple juice, about four cups of sweetening agent, about two ten inch cinnamon sticks, about four tsp. of cinnamon powder, and about four cups of alcoholic agent.

The sweetening agent used is, preferably, one of an artificial sweetener and sugar. Also, the alcoholic agent used is, preferably, 190-proof grain alcohol.

Combining flavors of the fall season, such as apple cider, with traditional pie spices including cinnamon and sugar, the alcoholic beverage mixture is a sweet concoction that delivers a punch, as it features 190-proof grain alcohol. The alcoholic beverage mixture is preferably served chilled, and can be customized by a bartender with cinnamon sticks, apple wedges or other garnishes. The alcoholic beverage mixture can also be poured over ice creams or other dessert items for an enhanced dining experience.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. An alcoholic beverage mixture consisting essentially of:
(a) a pre-selected amount of apple cider;
(b) a pre-selected amount of apple juice;
(c) a pre-selected amount of a sweetening agent;
(d) a pre-selected amount of cinnamon in the form of at least one of sticks and powder; and
(e) a pre-selected amount of an alcoholic agent.

2. An alcoholic beverage mixture, according to claim 1, wherein said pre-selected amounts of apple cider, apple juice, sweetening agent, and cinnamon are combined and brought to a boil for about seven minutes.

3. An alcoholic beverage mixture, according to claim 2, wherein said combination of apple cider, apple juice, sweetening agent and cinnamon are allowed to cool for about one hour.

4. An alcoholic beverage mixture, according to claim 3, wherein said alcoholic agent is added to said cooled combination.

5. An alcoholic beverage mixture, according to claim 1, wherein said pre-selected amount of apple cider is about one gallon.

6. An alcoholic beverage mixture, according to claim 1, wherein said pre-selected amount of apple juice is about ½ gallon.

7. An alcoholic beverage mixture, according to claim 1, wherein said pre-selected amount of sweetening agent is about four cups.

8. An alcoholic beverage mixture, according to claim 7, wherein said sweetening agent is one of an artificial sweetener and sugar.

9. An alcoholic beverage mixture, according to claim 1, wherein said pre-selected amount of cinnamon includes about two ten inch cinnamon sticks and about four tsp. cinnamon powder.

10. An alcoholic beverage mixture, according to claim 1, wherein said pre-selected amount of alcoholic agent is about four cups.

11. An alcoholic beverage mixture, according to claim 10, wherein said alcoholic agent is 190-proof grain alcohol.

12. A method of preparing an alcoholic beverage mixture, said method comprising the steps of:
(a) selecting a suitable container to combine said alcoholic beverage mixture in;
(b) pouring into said container a pre-selected amount of apple cider;
(c) pouring into said container a pre-selected amount of apple juice;
(d) adding a pre-selected amount of a sweetening agent to said pre-selected amounts of apple cider and apple juice poured into said container;
(d) adding a pre-selected amount of cinnamon in the form of at least one of sticks and powder to said pre-selected amounts of apple cider, apple juice and sweetening agent in said container;
(e) boiling said pre-selected amounts of apple cider, apple juice, sweetening agent and cinnamon mixed together in steps (a)-(d) a pre-selected amount of time;
(f) allowing said mixture boiled in step (e) to cool a pre-selected amount of time; and
(g) pouring a pre-selected amount of an alcoholic agent into said mixture cooled in step (f).

13. A method, according to claim 12, wherein said pre-selected amount of apple cider is about one gallon.

14. A method, according to claim 12, wherein said pre-selected amount of apple juice is about ½ gallon.

15. A method, according to claim 12, wherein said pre-selected amount of sweetening agent is about four cups.

16. A method, according to claim 15, wherein said sweetening agent is one of an artificial sweetener and sugar.

17. A method, according to claim 12, wherein said pre-selected amount of cinnamon includes about two ten inch cinnamon sticks and about four tsp. cinnamon powder.

18. A method, according to claim 12, wherein said pre-selected amount of alcoholic agent is about four cups.

19. A method, according to claim 18, wherein said alcoholic agent is 190-proof grain alcohol.
